(19) United States
(12) Patent Application Publication
(10) Pub. No.: US 2018/0051676 A1
(43) Pub. Date: Feb. 22, 2018

(54) AUTOMATIC AND INTELLIGENT CLUTCH-TYPE WIND TURBINE SYSTEM

(71) Applicants: RICHARD CHI-HSUEH, SAN DIEGO, CA (US); CHUNG-YEH HSU, NEW TAIPEI CITY (TW)

(72) Inventor: RICHARD CHI-HSUEH, SAN DIEGO, CA (US)

(21) Appl. No.: 15/662,547

(22) Filed: Jul. 28, 2017

Related U.S. Application Data
(60) Provisional application No. 62/375,873, filed on Aug. 16, 2016.

(51) Int. Cl. F03D 9/25; F03D 9/12; F03D 15/00; F16D 23/02

(52) U.S. Cl. CPC F03D 9/25; F03D 9/12; F16D 2023/0643; F16D 23/02; F03D 15/00

(57) ABSTRACT

An automatic and intelligent clutch-type wind turbine system clutch-type wind turbine system is revealed. A rotor-blade base is disposed with rotor blades and connected to a main shaft. A gearbox of a split gearbox is connected to the main shaft while a turbine-driven set of the split gearbox is connected to a power shaft. A plurality of sets of disc generators is connected to the power shaft and a synchronous clutch is arranged between the two adjacent disc generators. A battery is connected to each disc generator. Thereby electricity is generated by the wind turbine system without being affected by wind force from surrounding area and the electricity is not wasted on braking. During the electricity generation process, the energy stored is converted into kinetic energy for assistance in generating electricity. Thus not only the power generation efficiency is improved, the total production cost is also reduced.

### BACKGROUND OF THE INVENTION

### Field of the Invention

The present invention relates to a wind turbine system, especially to an automatic and intelligent clutch-type wind turbine system in which electricity is generated no matter the wind conditions and the electricity generated is not wasted on braking. During the power generation process, the energy stored is converted into kinetic energy for assistance in generating electricity so that not only the power generation efficiency is improved, the total production cost is also reduced.

### Description of Related Art

Generally, a conventional wind turbine generator generates power using wind force. Air on the earth is affected by heat from sun and earth rotation. Thus the rising and falling of hot air and cold air result in convection that creates wind. The wind force in nature is under influence of geographical environment, unstable and unable to control.

Refer to FIG. 5, a wind turbine generator 7 available now mainly includes a gearbox 71, at least one blade 72 disposed on a front end of the gearbox 71, a disc brake set 73 connected to a rear end of the gearbox 71, a generator 74 connected to the disc brake set 73, a battery 75 connected to the generator 74, and a hydraulic pump 76 connected to the generator 74. The hydraulic pump 76 controls actuation and braking of the disc brake set 73. The generator 74 is activated by speed increasing of the gearbox 71 to generate electricity while the blade 72 is blown by the wind. The electricity generated is stored in the battery 75.

Generally, the blade 72 of the wind turbine generator 7 is designed with an adjustable angle and certain surface area and the length thereof is ranging from 65 meters to 100 meters. Over 80% wind is passed through gaps among the three blades 72 and got lost when a strong wind is provided. On the other hand, the wind turbine generator 7 is unable to generate power when the wind power is not strong enough or the wind speed is quite low. The blade 72 of the wind turbine generator 7 starts rotating and driving the generator 74 to generator power when the cut-in wind speed reaches 3-4 meter/second. Thus the wind turbine generator 7 should be arranged at the area in which annual average wind speed is at least 4 meters/second and the area is considered as optimal place for wind development. The wind turbine generator 7 is stopped by braking and no more power is output to prevent overspeed damage to the wind turbine generator 7 when the wind speed is over 25 meters/second.

A brake is required for control of rotational speed of the main shaft and stabilization of the power generating process when the wind turbine generator 7 available now is in the strong wind. Thus a disc brake set 73 that takes a lot of electricity is disposed on the wind turbine generator 7 and the electricity generated by the generator 74 drives the hydraulic pump 76 for control of the disc brake set 73 to stop the wind turbine generator 7 and prevent burning of the generator 74 caused by overspeed. According to the statistics, 36-38% of the electricity generated by the wind turbine generator 7 is used for braking (slowing down). At the same time, the barking process also causes loss of the gearbox 71.

Thus there is room for improvement and there is a need to provide a novel wind turbine system that solves the above problems.

### SUMMARY OF THE INVENTION

Therefore it is a primary object of the present invention to provide an automatic and intelligent clutch-type wind turbine system in which electricity is generated no matter the wind conditions in surrounding area and the electricity generated is not consumed on braking. During the power generation process, the energy stored is converted into kinetic energy for assistance in generating electricity so that not only the power generation efficiency is increased, the total production cost is also reduced.

In order to achieve the above object, an automatic and intelligent clutch-type wind turbine system according to the present invention mainly includes a rotor-blade base, a split gearbox, a plurality of sets of disc generators, a plurality of synchronous clutches and a battery.

The rotor-blade base is disposed with a one-way fixed seat and a main shaft. The one-way fixed seat is used for fixing rotor blades and the main shaft is passed through a bearing.

The split gearbox consists of a gearbox and a turbine-driven set. The gearbox is connected to the main shaft of the rotor-blade base while the turbine-driven set is connected to a power shaft. The split gearbox is activated and the gearbox and the turbine-driven set are mechanically connected for driving the power shaft to rotate when the rotor blade of the rotor-blade base is driven by wind power in surrounding area.

The disc generator is connected to the power shaft of the split gearbox for being driven by the power shaft to rotate and generate electricity.

The synchronous clutch is arranged between the two adjacent disc generators. During rotation of the synchronous clutch being driven by the power shaft that drives the disc generator to rotate, the synchronous clutch is activated to drive the next set of the disc generator to rotate for generating electricity when the wind force is large enough to make the rotating synchronous clutch reach the rated speed.

The battery is connected to each set of the disc generator so that power generated by the respect disc generator can be delivered to the battery for storage.

The main shaft of the rotor-blade base is passed through not only the bearing but also a disc brake that is used for braking the main shaft.

The power shaft of the split gearbox is connected to and fixed with a synchronous jackshaft of the disc generator. A generator housing is fit around the synchronous jackshaft and an in-housing bearing is arranged between the generator housing and the synchronous jackshaft. A permanent-magnet rotor is mounted in the generator housing and is connected to and fixed on the synchronous jackshaft. A plurality of permanent-magnetic elements is connected to and driven by the permanent-magnet rotor. A plurality of electromagnetic induction silicon steels corresponding to the permanent-magnetic elements and wound with electromagnetic induction coils respectively is mounted in the generator housing.

The synchronous clutch is disposed between the two adjacent disc generators. An elastic element is set between the power shaft of the split gearbox and the synchronous jackshaft of the disc generator. A bearing is disposed between one end of the elastic element and the synchronous jackshaft while the other end of the elastic element is leaning against a toothed set. A lift and lock plate is set corresponding to the toothed set and a weight support is arranged corresponding to the lift and lock plate while the weight support is disposed with a weight. A fit gear arranged correspondingly to the toothed set is fit and fixed on a tandem axis. The tandem axis is used to connect and drive the next set of the disc generator.

The power shaft of the split gearbox is passed through a main gear of a high-pressure storage and pump tank while the main gear is engaged with two main tooth plates. Each main tooth plate is connected to an eccentric rotary disc and used for driving the eccentric rotary disc to rotate. The eccentric rotary disc is closely leaning against a smooth running member and a support is pivotally connected to a middle part of the smooth running member while each of two sides of the smooth running member is pivotally connected to a valve rod. The valve rod is connected to a piston member and each piston member is arranged with an intake valve and an exhaust valve corresponding to each other. The intake valve is connected to an intake channel for introducing air outside while the exhaust valve is connected to a compression chamber. The compression chamber is connected to an energy storage tank by an air outlet and the energy storage tank is connected to the turbine-driven set of the split gearbox. The air introduced is compressed to be stored in the energy storage tank in the form of high pressure gas while the power shaft drives the main gear to rotate. When the wind power from the surrounding area is insufficient to activate the rotor blades, energy in the form of high-pressure gas stored in the energy storage tank is sent to the turbine-driven set for driving the turbine-driven set and further driving the power shaft to rotate and generate electricity.

The high-pressure storage and pump tank further includes a maintenance cover that is used for repair and maintenance of the high-pressure storage and pump tank.

The high-pressure storage and pump tank further includes a speed regulator that is used to adjust operation speed of the high-pressure storage and pump tank.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing system structure of an embodiment according to the present invention;

FIG. 2 is another schematic drawing showing system structure of an embodiment according to the present invention;

FIG. 3 is a schematic drawing showing a high-pressure storage and pump tank of an embodiment according to the present invention;

FIG. 4 is a schematic drawing showing a disc generator and a synchronous clutch of an embodiment according to the present invention;

FIG. 5 is a schematic drawing showing system structure of a prior art.

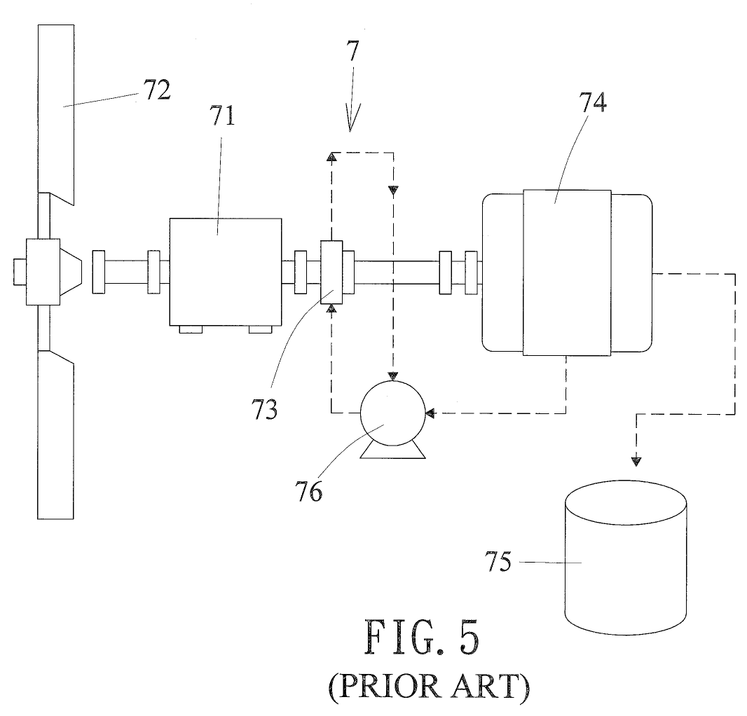

### DETAILED DESCRIPTION OF THE PREFERRED EMBODIMENT

In order to learn technical content, purposes and functions of the present invention, please refer to the following embodiments, related figures and reference number.

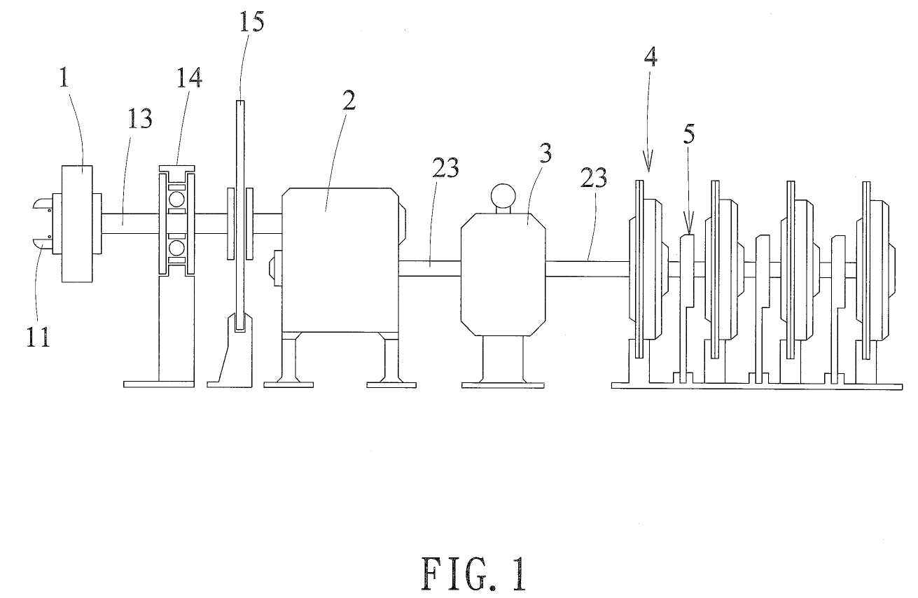

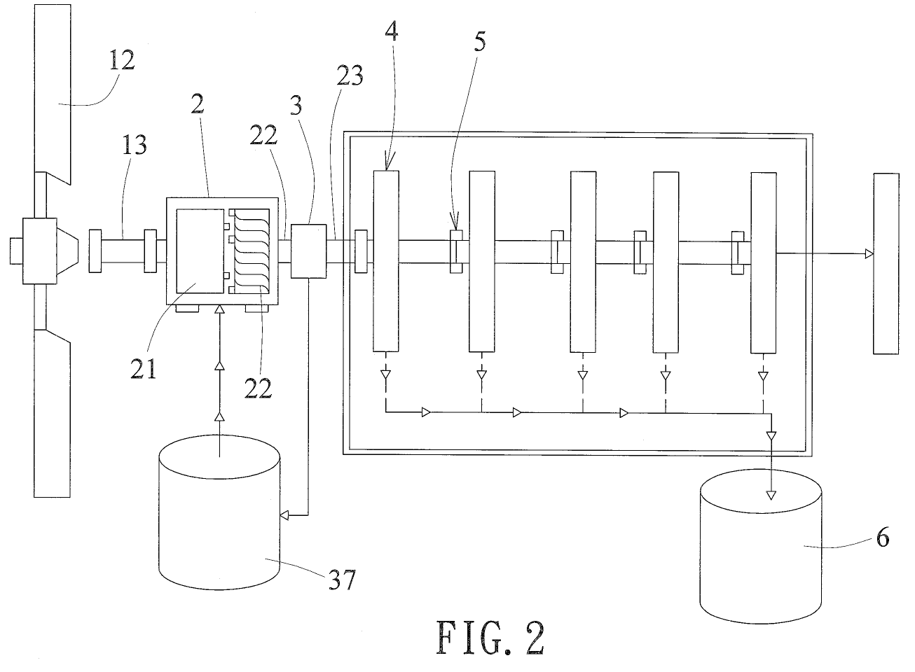

Refer to FIG. 1 and FIG. 2, an automatic and intelligent clutch-type wind turbine system according to the present invention mainly includes a rotor-blade base 1, a split gearbox 2, a high-pressure storage and pump tank 3, a plurality of disc generators 4, a plurality of synchronous clutches 5 and a battery 6.

The rotor-blade base 1 is disposed with a one-way fixed seat 11 used for fixing at least one rotor blade 12. Compared with the rotor blade available now, the present rotor blade 12 has a larger width and a smaller length. A main shaft 13 is connected to the rotor-blade base 1 and passed through a bearing 14 and a disc brake 15. The disc brake 15 is operated automatically by a computer system or manually by users for braking the main shaft 13 under certain conditions (such as maintenance and repair, an unexpected emergency situation, etc.).

The split gearbox 2 consists of a gearbox 21, a turbine-driven set 22 and a power shaft 23. The gearbox 21 is connected to the main shaft 13 of the rotor-blade base 1 while the turbine-driven set 22 is connected to the power shaft 23. The split gearbox 2 can be operated manually by the user or automatically by a computer system. The split gearbox 2 is activated and a mechanical connection is formed between the gearbox 21 and the turbine-driven set 22 for driving the power shaft 23 to rotate when the rotor blade 12 of the rotor-blade base 1 is triggered by wind power in the surrounding area. Once there is no sufficient wind energy from the surrounding area and the rotor blade 12 is unable to be activated, the gearbox 21 and the turbine-driven set 22 are mechanically separated from each other.

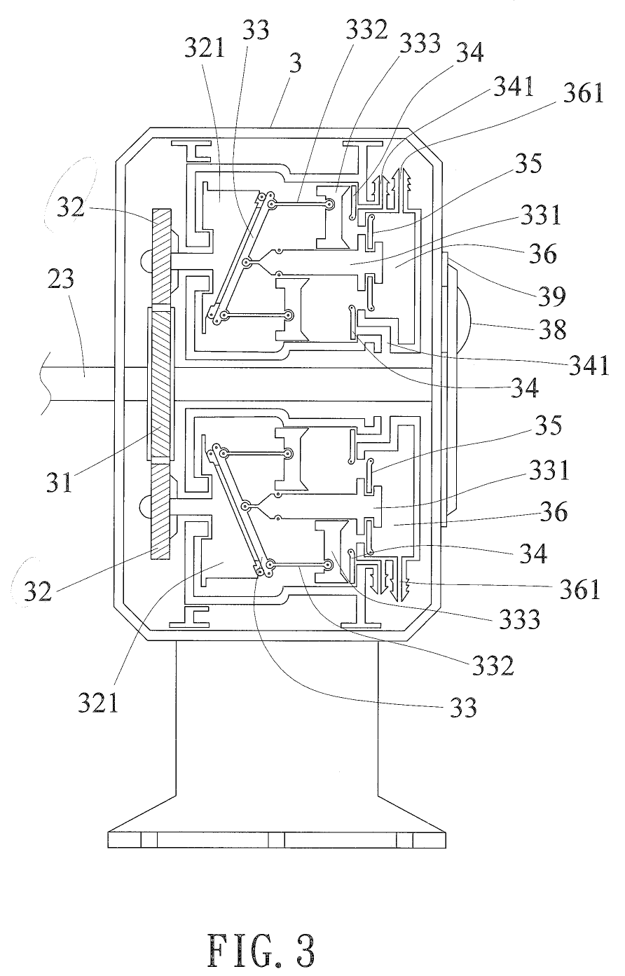

As shown in FIG. 3, the high-pressure storage and pump tank 3 is composed of a main gear 31, two main tooth plates 32, two smooth running members 33, four intake valves 34, four exhaust valves 35, two compression chambers 36, an energy storage tank 37, a maintenance cover 38 and a speed regulator 39. The power shaft 23 of the split gearbox 2 is passed through the main gear 31 while the main gear 31 is engaged with the main tooth plates 32. Each main tooth plate 32 is connected to an eccentric rotary disc 321 and used for driving the eccentric rotary disc 321 to rotate. The eccentric rotary disc 321 is closely leaning against the smooth running member 33 and a support 331 is pivotally connected to a middle part of the smooth running member 33 while each of two sides of the smooth running member 33 is pivotally connected to a valve rod 332.

The valve rod 332 is connected to a piston member 333 and each piston member 333 is arranged with the intake valve 34 and the exhaust valve 35 corresponding to each other. The intake valve 34 is connected to an intake channel 341 for introducing air outside while the exhaust valve 35 is connected to the compression chamber 36. The compression chamber 36 is connected to the energy storage tank 37 by an air outlet 361 and the energy storage tank 37 is connected to the turbine-driven set 22 of the split gearbox 2. By manual operation or automatic operation of the computer system, the energy storage tank 37 delivers the high-pressure gas stored therein into the turbine-driven set 22 of the split gearbox 2. Thus the main tooth plate 32 also drives the eccentric rotary disc 321 to rotate while the power shaft 23 drives the main gear 31 to rotate. The eccentric rotary disc 321 pushes the smooth running member 33 to swing for pushing/pulling the piston members 333 to work by the valve rods 332. The intake valve 34 is opened and the exhaust valve 35 is closed when the piston member 333 is pulled by the valve rod 332 to move outward. Thus air outside is introduced through the intake channel 341 and the intake valve 34. The intake valve 34 is closed and the exhaust valve 35 is opened when the piston member 333 is pushed by the valve rod 332 to move inward. Thus the air introduced is passed through the exhaust valve 35 to be compressed into the compression chamber 36. When the pressure reaches the maximum value of the compression chamber 36, the compressed air is delivered into the energy storage tank 37 through the air outlet 361. The maintenance cover 38 is for convenient maintenance and repair operation and the speed regulator 39 is used to adjust operation speed of the high-pressure storage and pump tank 3.

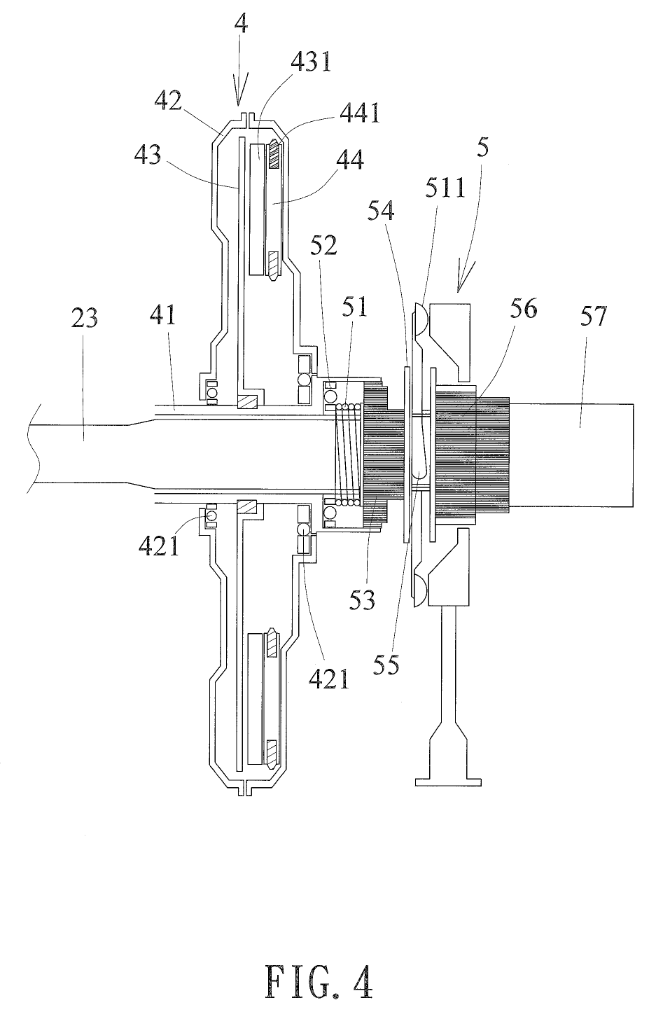

Refer to FIG. 4, the disc generator 4 and the synchronous clutch 5 are revealed. As shown in FIG. 1, there is a plurality of sets of the disc generator 4 included in the present system. The disc generator 4 includes a synchronous jackshaft 41, a generator housing 42, a permanent-magnet rotor 43 and a plurality of electromagnetic induction silicon steels 44. The synchronous jackshaft 41 is connected to and fixed on the power shaft 23 of the split gearbox 2. The generator housing 42 is fit around the synchronous jackshaft 41 and an in-housing bearing 421 is arranged between the generator housing 42 and the synchronous jackshaft 41. The permanent-magnet rotor 43 is mounted in the generator housing 42 and is connected to and fixed on the synchronous jackshaft 41. A plurality of permanent-magnetic elements 431 is connected to and driven by the permanent-magnet rotor 43. A plurality of electromagnetic induction silicon steels 44 corresponding to the permanent-magnetic elements 431 and wound with electromagnetic induction coils 441 respectively is mounted in the generator housing 42. An electric current is induced in the electromagnetic induction coils 441 of the electromagnetic induction silicon steel 44 by the permanent-magnetic elements 431 when the permanent-magnet rotor 43 drives the permanent-magnetic elements 431 to rotate.

Still refer to FIG. 1 and FIG. 4, the synchronous clutch 5 is disposed between the two adjacent disc generators 4. The synchronous clutch 5 consists of an elastic element 51, a bearing 52, a toothed set 53, a lift and lock plate 54, a weight support 55, a fit gear 56, and a tandem axis 57. The elastic element 51 is fit between the synchronous jackshaft 41 of the disc generator 4 and the power shaft 23 of the split gearbox 2. The bearing 52 is disposed between one end of the elastic element 51 and the synchronous jackshaft 41 while the other end of the elastic element 51 is leaning against the toothed set 53. The lift and lock plate 54 is disposed corresponding to the toothed set 53 and the weight support 55 is arranged corresponding to the lift and lock plate 54 while the weight support 55 is disposed with a weight 551. The fit gear 56 arranged correspondingly to the toothed set 53 is fit and fixed on the tandem axis 57. The tandem axis 57 is used to connect and drive the next set of the disc generator 4. The weight support 55 makes the weight 551 to lift and expand outward when the rotating synchronous clutch 5 reaches the preset rated speed. Thus the lift and lock plate 54 is moved inward and the toothed set 53 is pushed by the elastic element 51 to be connected to the fit gear 56. Therefore the tandem axis 57 fit with the fit gear 56 is driven to rotate and the next set of the disc generator 4 is further driven to rotate and generate power.

Refer to FIG. 2, the battery 6 is connected to each set of the disc generator 4 so that power generated by the respect disc generator 4 can be delivered to the battery 6 for storage.

When the rotor blade 12 of the rotor-blade base 1 is triggered by wind power from the surrounding area, the main shaft 13 of the rotor-blade base 1 is activated and a mechanical connection is formed between the gearbox 21 and the turbine-driven set 22. Thus the power shaft 23 is driven to rotate by the turbine-driven set 22. The gearbox 21 and the turbine-driven set 22 are mechanically separated from each other when the wind power from the surrounding area is insufficient to activate the rotor blade 12. At the moment, energy in the form of high-pressure gas stored in the energy storage tank 37 of the high-pressure storage and pump tank 3 is delivered to the turbine-driven set 22 by the computer system or manual operation for driving the turbine-driven set 22 and further driving the power shaft 23 to rotate. The power shaft 23 further drives the first set of the disc generator 4 to rotate and generate electricity. During rotation of the synchronous clutch 5 being driven by the power shaft 23 that drives the disc generator 4 to rotate, the first synchronous clutch 5 is activated to drive the second set of the disc generator 4 and the second synchronous clutch 5 to rotate for generating electricity and to rotate respectively when the wind power is large enough to make the rotating synchronous clutch 5 reach the preset rated speed. The second synchronous clutch 5 is also activated to drive the third set of the disc generator 4 and the third synchronous clutch 5 to rotate for generating electricity and to rotate respectively when the wind power is getting larger and the second synchronous clutch 5 is reaching the preset rated speed. Each of the synchronous clutches 5 is used to drive the next set of the disc generator 4 for rotating and generating electricity in turn according to the magnitude of the wind force. The electricity generated is sent to the battery 6 for storage.

In summary, the present invention generates electricity no matter the wind force is high or low and the electricity is not wasted on braking. During the electricity generation process, the energy stored is converted into kinetic energy for assistance in generating electricity. Thus not only the power generation efficiency is improved, the total production cost is also reduced.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An automatic and intelligent clutch-type wind turbine system comprising: a rotor-blade base, a split gearbox, a plurality of sets of disc generators, a plurality of synchronous clutches and a battery;
wherein the rotor-blade base is disposed with a one-way fixed seat for fixing at least one rotor blade and a main shaft is connected to the rotor-blade base and passed through a bearing;
wherein the split gearbox includes a gearbox and a turbine-driven set; the gearbox is connected to the main shaft of the rotor-blade base while the turbine-driven set is connected to a power shaft; the split gearbox is activated and a mechanical connection is formed between the gearbox and the turbine-driven set for driving the power shaft to rotate when the rotor blade of the rotor-blade base is driven by wind power from surrounding area;
wherein each of the disc generators is connected to the power shaft of the split gearbox for being driven by the power shaft to rotate and generate electricity;
wherein the synchronous clutch is arranged between the two adjacent disc generators; during rotation of the synchronous clutch being driven by the power shaft that drives the disc generator to rotate, the synchronous clutch is activated to drive the next set of the disc generator to rotate for generating electricity when the wind power is large enough to make the rotating synchronous clutch reach the rated speed;
wherein the battery is connected each of the disc generators so that power generated by each of the disc generators is able to be delivered to the battery for storage.

2. The system as claimed in claim 1, wherein the main shaft of the rotor-blade base is passed through not only the bearing but also a disc brake that is used for braking the main shaft.

3. The system as claimed in claim 1, wherein the power shaft of the split gearbox is connected to and fixed with a synchronous jackshaft of the disc generator while a housing is fit around the synchronous jackshaft and an in-housing bearing is arranged between a generator housing and the synchronous jackshaft; a permanent-magnet rotor is mounted in the generator housing and is connected to and fixed on the synchronous jackshaft; a plurality of permanent-magnetic elements is connected to and driven by the permanent-magnet rotor; a plurality of electromagnetic induction silicon steels corresponding to the permanent-magnetic elements and wound with electromagnetic induction coils respectively is mounted in the generator housing.

4. The system as claimed in claim 1, wherein the synchronous clutch is disposed between the two adjacent disc generators; an elastic element is set between the power shaft of the split gearbox and the synchronous jackshaft of the disc generator; a bearing is disposed between one end of the elastic element and the synchronous jackshaft while the other end of the elastic element is leaning against a toothed set; a lift and lock plate is set correspondingly to the toothed set and a weight support is arranged corresponding to the lift and lock plate while the weight support is disposed with a weight; a fit gear arranged correspondingly to the toothed set is fit and fixed on a tandem axis while the tandem axis is used to connect and drive the next set of the disc generator.

5. The system as claimed in claim 1, wherein the power shaft of the split gearbox is passed through a main gear of a high-pressure storage and pump tank while the main gear is engaged with two main tooth plates; each main tooth plate is connected to an eccentric rotary disc and used for driving the eccentric rotary disc to rotate; the eccentric rotary disc is closely leaning against a smooth running member and a support is pivotally connected to a middle part of the smooth running member while each of two sides of the smooth running member is pivotally connected to a valve rod; the valve rod is connected to a piston member and each of the piston member is arranged with an intake valve and an exhaust valve corresponding to each other; the intake valve is connected to an intake channel for introducing air outside while the exhaust valve is connected to a compression chamber that is connected to an energy storage tank by an air outlet and the energy storage tank is connected to the turbine-driven set of the split gearbox; the high-pressure gas is compressed to be stored in the energy storage tank while the power shaft drives the main gear to rotate; when the wind power from the surrounding area is insufficient to activate the rotor blade, energy from the high-pressure gas stored in the energy storage tank is sent to the turbine-driven set for driving the turbine-driven set and further driving the power shaft to rotate and generate electricity.

6. The system as claimed in claim 5, wherein the high-pressure storage and pump tank further includes a maintenance cover that is used for repair and maintenance thereof

7. The system as claimed in claim 5, wherein the high-pressure storage and pump tank further includes a speed regulator that is used to adjust operation speed thereof.
